(19) United States
(12) Patent Application Publication
(10) Pub. No.: US 2020/0216022 A1
(43) Pub. Date: Jul. 9, 2020

(54) Intelligent Vehicle Security System Using V2X Communication Network with Non Broadcast Protocol

(71) Applicant: SDC INTERNATIONAL, LLC, Plano, TX (US)

(72) Inventor: Hui CHENG, Plano, TX (US)

(21) Appl. No.: 16/647,515

(22) PCT Filed: Jun. 13, 2018
(86) PCT No.: PCT/US18/37416

§ 371 Date: Mar. 15, 2020

Related U.S. Application Data
(60) Provisional application No. 62/560,920, filed on Sep. 20, 2017.

(51) Int. Cl. B60R 25/102; H04W 4/40; H04W 4/12; G08B 13/196; B60R 25/30; B60R 25/01; B60Q 5/00; B60Q 9/00

(52) U.S. Cl. CPC B60R 25/102; H04W 4/40; H04W 4/12; G08B 13/19695; B60Q 9/00; B60R 25/305; B60R 25/01; B60Q 5/005; G08B 13/19658

(57) ABSTRACT

The invention relates to a method of using the V2X non-broadcast communication protocol to ensure and monitor the physical security of an unoccupied passenger vehicle or other conveyance such as a watercraft using an array of attached sensors and cameras installed on passenger vehicles and watercraft. The system will also automatically send alert massage and image data to vehicle owner when a break-in or vehicle theft event has been detected.

### CROSS-REFERENCE TO RELATED APPLICATIONS

This application takes benefit of U.S. Prov. App. No. 62/560,920 filed on Sep. 20, 2017 and incorporates it, in its entirety, by reference.

### FIELD OF THE INVENTION

The present invention relates to a method of using the V2X communication protocol to ensure and monitor the physical security of an unoccupied passenger vehicle or conveyance using the array of attached sensors and cameras installed on passenger vehicles and watercraft, such as Driver Monitoring System or In-vehicle Cabin Monitor.

### BACKGROUND OF THE INVENTION

Passenger vehicles have been equipped with security and antitheft systems for many decades. Indeed, today it is not uncommon for a passenger vehicle to be equipped with at least four or five cameras and several dozen sensors and switches used to detect events transpiring in, and on, the passenger vehicle. Not as frequently recreational and commercial watercraft are also equipped with such devices. Such as Driver Monitoring System or In-vehicle Cabin Monitor.

Most of these security and antitheft systems are based on GPS receivers, accelerometers and break detectors. Carbon monoxide and thermal detectors are all part of the universe of sensors and switches used to detect events transpiring in, and on, the passenger vehicle or watercraft.

V2X is a form of communication technology that allows vehicles to communicate with moving parts of the traffic system around them. V2X exists in three primary forms: 1) V2V, or vehicle to vehicle, allowing vehicles to communicate with other vehicles with broadcast protocol; 2) V2I, or vehicle to infrastructure, allowing vehicles to communicate with external systems such as streetlights, buildings, and even cyclists with broadcast protocol; and, 3) V2P, or vehicle to personal, allowing vehicles to communicate with individual personal handsets and tablet computers with non-broadcast protocol.

V2X systems are geared toward safety and they can be programmed to be aware of all surroundings to help prevent collision. In a traditional vehicle, V2X systems can convey important information to the driver or operator regarding inclement weather, nearby accidents and road conditions, and the dangerous activities of nearby vehicles/watercraft. Similarly, in autonomous vehicles, V2X provides extra information beyond the reach of the vehicle or watercraft. In addition to safety benefits, V2X technology also offers a range of everyday convenience benefits. For example, V2X systems integrate automatic payments for tolls, parking, and similar fees.

It is well known that the broadcast protocol is widely used in V2X Communication Network. But it is not a good way to be used in transmission and reception of security and safety messages, particularly those attempting to steal or damage the personal vehicle/watercraft that is in park or moored, with the key off, and no occupants inside the vehicle/watercraft. With the security concerns, non-broadcast protocol will be considered to be used in transmission and reception of security messages. The Non-broadcast protocol is a point to point secure communication protocol for all messages transition and reception. A point to point secure communication protocol is very important for vehicle anti-theft system. In an unsecure message broadcast communication protocol system, the intruder or burglar could be able to receive the broadcasted vehicle theft warning message. The intruder or burglar may take some actions such as to destroy the communication equipment in the vehicle before continuing the criminal act after receiving vehicle theft warning message.

Accordingly, a first embodiment of the present invention is directed towards transmitting discrete messaging via V2X with non-broadcast protocol directed to the unoccupied passenger vehicle/watercraft from the owner's (V2P) or third party agent's (V2P) cell phone, laptop, or tablet computer to: 1) Initiate system operation; 2) Immobilize the engine of the vehicle/watercraft; 3) Flash the light(s) of the vehicle/watercraft; 4) Activate continuously, or rhythmically, the car or watercraft horn; and, 5) Activate continuously, or rhythmically, the windshield wipers.

A second embodiment of the present invention is directed towards transmitting discrete messaging via V2X with non-broadcast protocol from the unoccupied passenger vehicle/watercraft to the owner's (V2P) or third party agent's (V2P) cell phone, laptop, or tablet computer including image data collected by the: 1) Front view camera; 2) Left view camera; 3) Rear view camera; 4) Right view camera; 5) Front facing camera, or Driver Monitoring System; 6) Driver gesture monitor camera; and 7) In-vehicle cabin monitor if it is equipped.

### SUMMARY OF THE INVENTION

One embodiment of the present invention presents a method of detecting a car or watercraft thief or intruder by means well known in the art and then automatically immobilizing the engine of the vehicle. Simultaneously, the system powers on the cameras installed in the automobile/watercraft, activates Driver Monitoring System if it is equipped, and in-vehicle cabin monitor if it is equipped. Next, the system transmits alert messages to the owner's cell phone, laptop, or tablet computer with non-broadcast protocol via V2P. Next, the system initiates collection of image data from the cameras installed in the automobile/watercraft, or from Driver Monitoring System if it is equipped, and in-vehicle cabin monitor if it is equipped. Next, the system processes the image data into a form that may be transmitted by V2P, and system transmits collected images including intruder or burglar's images to the owner's cell phone, laptop, or tablet computer with non-broadcast protocol. Next, the system receives a confirmation message from the owner of the automobile via V2P. Next, the system may receive a confirmation message from the police or other authorities via V2I.

A second embodiment of the present invention presents a method of detecting a car or watercraft thief or intruder by means well known in the art. Simultaneously, the system powers on the cameras installed in the automobile/watercraft, and activates the driver monitoring system and/or in-vehicle cabin monitor if it is equipped. Next, the system transmits alert messages to the owner's cell phone, laptop, or tablet computer with non-broadcast protocol via V2P. Next, the system initiates collection of image data from the cameras installed in the automobile/watercraft, and intruder's images will be collected by driver monitoring system and in-vehicle cabin monitor if it is equipped. Next, the system processes the image data into a form that may be transmitted by V2P. Next, the system transmits images collected by the system including intruder's images to the owner's cell phone, laptop, or tablet computer with non-broadcast protocol via V2P. Next, the system receives a confirmation message from the owner of the automobile via V2P. This message serves to immobilize the engine of the automobile/watercraft. Also, the system may receive a confirmation message from the police or other authorities via V2I.

A third embodiment of the present invention presents a method of surveying the automobile and the environment around it. First, the owner initiates the system via V2P. Next, the system powers on the cameras installed in the automobile/watercraft, and activates the driver monitoring system and/or in-vehicle cabin monitor if it is equipped. Next, the system initiates collection of image data from the cameras installed in the automobile/watercraft, and the driver monitoring system and/or in-vehicle cabin monitor if it is equipped. Next, the system processes the image data into a form that may be transmitted by V2P. Next, the system transmits messages to the owner via V2P containing the images collected by the system. Next, the system receives a confirmation message from the owner of the automobile via V2P. This message may serve to immobilize the engine of the automobile/watercraft.

### BRIEF DESCRIPTION OF THE DRAWINGS

FIG. 1 is a schematic view of the operation of the invention in one embodiment of the present invention.

FIG. 2 is a schematic view of the operation of the invention of a second embodiment of the present invention.

FIG. 3 is a schematic view of the operation of the invention of a third embodiment of the present invention.

### DETAILED DESCRIPTION OF THE INVENTION

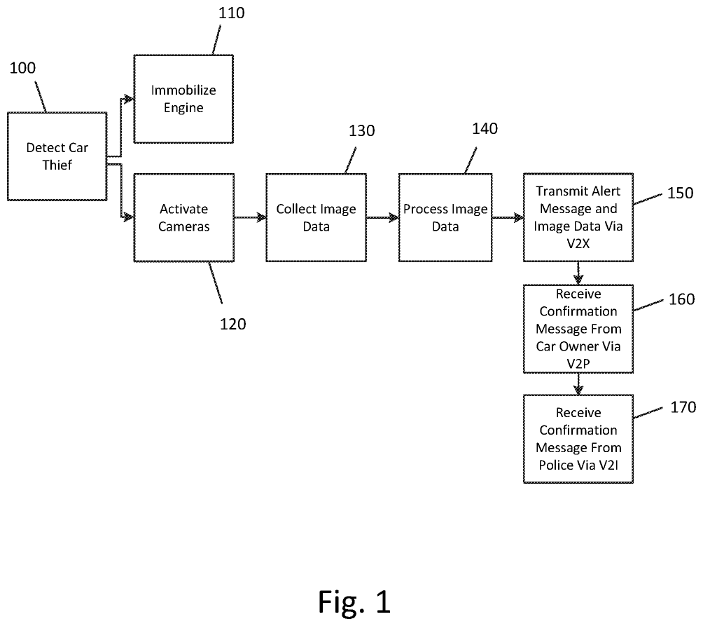

Turning now to FIG. 1, one embodiment of the present invention presents a method of detecting a car or watercraft thief or intruder by means well known in the art (100). Such means include vibration detection, glass break detection, motion detection, etc. Next, the system automatically immobilizes the engine of the vehicle/watercraft (110). Ordinarily this is done by disabling the fuel delivery system and/or the ignition system of the automobile/watercraft powered by an internal combustion engine. Electric vehicles are disabled by a command to the processing unit that governs the operation of the vehicle. Simultaneously, the system powers on the cameras installed in the automobile (120) and activates them. Next, the system transmits alert messages to the owner's cell phone, laptop, or tablet computer with non-broadcast protocol via V2P (125). Next, the system initiates collection of image data from the cameras installed in the automobile, and the driver monitoring system and/or in-vehicle cabin monitor if it is equipped (130). Next, the system processes the image data into a format that may be transmitted by V2P and V2I (140). Next, the system transmits the images including intruder's images to the owner's cell phone, laptop, or tablet computer with non-broadcast protocol via V2P and/or the authorities via V2I. Next, the system receives a confirmation message from the owner of the automobile via V2P (160). Also, the system may receive a confirmation message from the police or other-authorities via V2I (170).

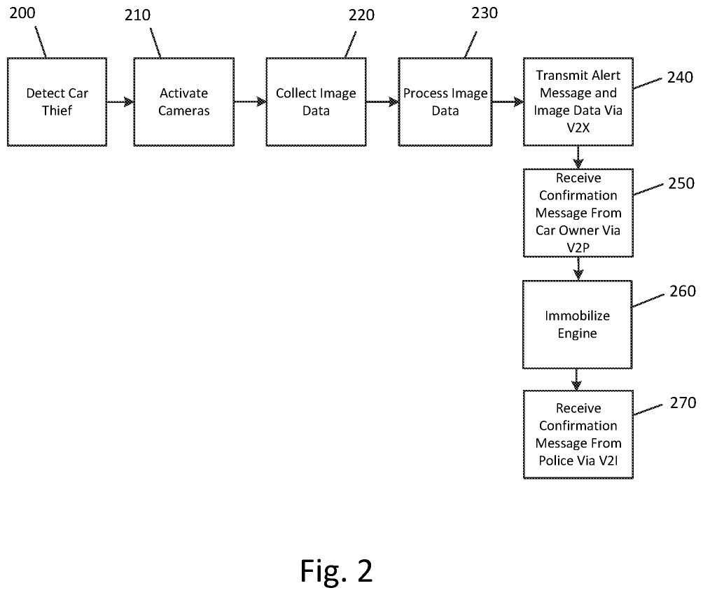

Turning now to FIG. 2, a second embodiment of the present invention presents a method of detecting a car or watercraft thief or intruder by means well known in the art (200). Such means include vibration detection, glass break detection, motion detection, etc. Next, the system powers on the cameras installed in the automobile/watercraft (210) and activates them, and the driver monitoring system and/or in-vehicle cabin monitor if it is equipped. Next, the system transmits alert messages to the owner's cell phone, laptop, or tablet computer with non-broadcast protocol via V2P (215). Next, the system initiates collection of image data from the cameras installed in the automobile/watercraft, and the driver monitoring system and/or in-vehicle cabin monitor if it is equipped (220). Next, the system processes the image data into a format that may be transmitted by V2P and V2I (230). Next, the system transmits collected image data including intruder's image to the owner's cell phone, laptop, or tablet computer with non-broadcast protocol via V2P and/or the authorities via (240). Next, the system receives a confirmation message from the owner of the automobile via V2P (250). This message may immobilize the engine of the automobile/watercraft (260). Ordinarily this is done by disabling the fuel delivery system and/or the ignition system of the automobile/watercraft powered by an internal combustion engine. Electric vehicles are disabled by a command to the processing unit that governs the operation of the vehicle. Also, the system may receive a confirmation message from the police or other authorities via V2I (270).

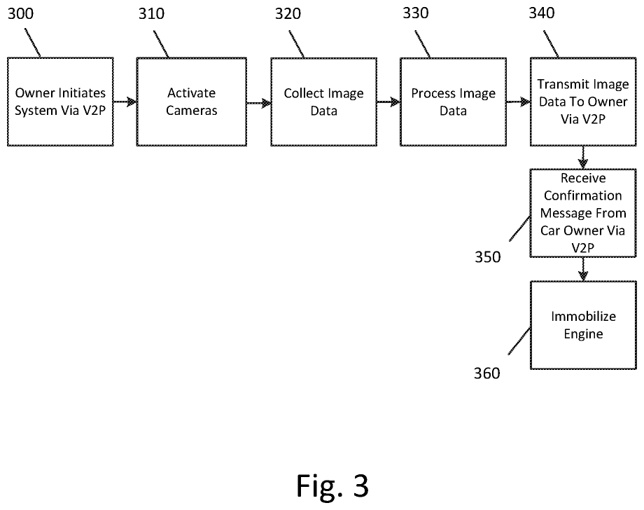

Turning now to FIG. 3, a third embodiment of the present invention presents a method of surveying the automobile/watercraft and its environment. Such a method might be used prior to the owner entering the vehicle/watercraft in the middle of the night, or to survey the area in and about the automobile/watercraft periodically during the day. First, the owner initiates the system via V2P (300). Next, the system powers on the cameras installed in the automobile/watercraft (310) and activates them. Next, the system initiates collection of image data from the cameras installed in the automobile/watercraft, and the driver monitoring system and/or in-vehicle cabin monitor if it is equipped (320). Next, the system processes the image data into a format that may be transmitted by V2P (330). Next, the system transmits the collected images including intruder's images to the owner's cell phone, laptop, or tablet computer with non-broadcast protocol via V2P (340). Next, the system receives a confirmation message from the owner of the automobile/watercraft via V2P (350). This message may serve to immobilize the engine of the automobile/watercraft (360). Ordinarily this is done by disabling the fuel delivery system and/or the ignition system of the automobile/watercraft powered by an internal combustion engine. Electric vehicles are disabled by a command to the processing unit that governs the operation of the vehicle/watercraft.

While the present invention has been described in what are thought to be the most useful and practical embodiments, it will be clear to those having skill in the art that other variations may be readily conceived and created. Accordingly, these and all such other readily conceived and created variations are implicitly included in the spirit and scope of the present disclosure.

For example, the present application discloses that the system may be installed on motor vehicles and watercraft. Those having skill in the art will recognize that other types of vehicles may also be equipped with this kind of system. For example aircraft and spacecraft may also be equipped with such a device.

What is claimed is:

1. A method of transmitting discrete image messaging using non-broadcast protocol via V2X from an unoccupied passenger vehicle/watercraft to the owner's (V2P) cell phone, laptop, or tablet computer, including image data derived from:
a) Front view camera;
b) Left view camera;
c) Rear view camera;
d) Right view camera;
e) Front-facing camera;
f) Driver gesture monitor camera;
g) Driver Monitoring System if equipped; and
h) In-vehicle Cabin Monitor if equipped.

2. A method of transmitting discrete messaging using non-broadcast protocol via V2X directed to an unoccupied passenger vehicle/watercraft from the owner's (V2P) cell phone, laptop, or tablet computer, to:
a) Initiate system operation;
b) Immobilize the engine of the vehicle/watercraft;
c) Flash the light(s) of the vehicle/watercraft;
d) Activate continuously, or rhythmically, the vehicle/watercraft horn; and
e) Activate continuously, or rhythmically, the windshield wipers.

3. A method of transmitting discrete messaging using non-broadcast protocol via V2X directed to an unoccupied passenger vehicle/watercraft from a third party agent's (V2P) cell phone, laptop, or tablet computer, to:
a) Initiate system operation;
b) Immobilize the engine of the vehicle/watercraft;
c) Flash the light(s) of the vehicle/watercraft;
d) Activate continuously, or rhythmically, the windshield wipers.

4. A method of transmitting discrete messaging using non-broadcast protocol via V2X from an unoccupied passenger vehicle/watercraft to the third party agent's (V2P) cell phone, laptop, or tablet computer, including image data derived from:
a) Front view camera;
b) Left view camera;
c) Rear view camera;
d) Right view camera;
e) Front-facing camera;
f) Driver gesture monitor camera;
g) Driver Monitoring System if equipped; and
h) In-vehicle Cabin Monitor if equipped.

5. A method of transmitting discrete alert messaging using non-broadcast protocol via V2X directed from an unoccupied passenger vehicle/watercraft to the owner's (V2P) cell phone, laptop, or tablet computer once a break-in or vehicle theft event has been detected.
